(19) United States
(12) Patent Application Publication
(10) Pub. No.: US 2026/0188961 A1
(43) Pub. Date: Jul. 2, 2026

(54) PLUG ADAPTOR

(71) Applicant: Anker Innovations Technology Co., Ltd., CHANGSHA (CN)

(72) Inventor: Xianjie TANG, SHENZHEN (CN)

(73) Assignee: Anker Innovations Technology Co., Ltd., CHANGSHA (CN)

(21) Appl. No.: 19/376,720

(22) Filed: Oct. 31, 2025

(30) Foreign Application Priority Data
Dec. 31, 2024 (CN) 202411999120.7

(51) Int. Cl. H01R 31/06; H01R 13/44; H01R 27/00

(52) U.S. Cl. CPC H01R 31/06; H01R 13/44; H01R 27/00

(57) ABSTRACT

A plug adaptor, which includes a housing, a first plug, at least one rocker assembly, an electrical connection assembly, and a second plug. Each rocker assembly includes a rocker plate that is rotatable relative to the housing. The first plug includes at least two first plug pins rotatably arranged on the housing. During rotation of each first plug pin, the first plug pin has a raised position where the rocker plate is electrically connected to the electrical connection assembly, and the first plug pin further has a retracted position where the rocker plate is electrically disconnected from the electrical connection assembly. The second plug has an in-use state where the second plug is connected to mains power and electrically connected to the power connection assembly. When the second plug is in the in-use state, the first plug switches to the retracted position.

### CROSS-REFERENCE TO RELATED APPLICATIONS

The present application claims priority of Chinese Patent Application No. 202411999120.7, filed on Dec. 31, 2024, the entire contents of which are hereby incorporated by reference in their entirety.

### TECHNICAL FIELD

The present disclosure relates to the technical field of electrical equipment, specifically to a plug adaptor.

### BACKGROUND

Due to divergent plug standards and charging interface specifications across nations, the demand for unified global compatibility in business travel, overseas assignments, and international studies has driven the development of multi-standard plug adaptors.

However, in the related art, the conventional plug adaptors exhibit a critical flaw: when one plug is engaged, residual plugs remain electrically connected to an electrical connection assembly, maintaining an energized state. This configuration poses significant electrocution risks upon incidental contact with exposed contacts. Furthermore, residual energized components may induce internal arcing and dielectric breakdown within the plug adaptor, resulting in localized thermal escalation. Such conditions potentially culminate in fire hazards and systemic safety compromises.

### SUMMARY OF THE DISCLOSURE

The embodiments of the present disclosure provide a plug adapter that is designed to disconnect the electrical connection between the plug in the retracted position and the electrical connection assembly by means of a rocker assembly, such that the plug in the retracted position is in a power-off state, thereby improving the safety of the plug adapter.

A plug adaptor, comprising:
a housing;
an electrical connection assembly, arranged within the housing;
at least one rocker assembly, arranged within the housing and each comprising a rocker plate that is rotatable relative to the housing;
a first plug, comprising at least two first plug pins rotatably arranged on the housing; wherein at least one of the at least two first plug pins slidably abuts against the rocker plate of a corresponding one of the at least one rocker assembly to establish an electrical connection;
wherein for each first plug pin of the at least one of the at least two first plug pins: during rotation of the first plug pin, the first plug pin has a first raised position where the rocker plate corresponding to the first plug pin rotates to a state, in which the rocker plate is electrically connected to the electrical connection assembly, and the first plug pin further has a first retracted position where the rocker plate corresponding to the first plug pin rotates to a state, in which the rocker plate is electrically disconnected from the electrical connection assembly; and
a second plug, arranged on the housing; wherein the second plug has an in-use state where the second plug is connected to mains power and electrically connected to the power connection assembly; in a case where the second plug is in the in-use state, the first plug switches to the first retracted position.

Based on the plug adaptor as proposed in the present disclosure, when the second plug is in the in-use state, the first plug switches to the retracted position, and the first plug is disconnected from the electrical connection assembly via the rocker plate, thereby preventing users from coming into contact with the first plug pin and being electrocuted, and thus improving the safety of the power adapter. In addition, when the first plug switches to the raised position, the first plug pin is electrically connected to the electrical connection assembly via the rocker plate, allowing the user to connect the first plug to the mains power, so as to use the plug adaptor.

### BRIEF DESCRIPTION OF THE DRAWINGS

To more clearly illustrate the technical solutions of the embodiments of the present disclosure or the related art, the following is a brief introduction to the drawings required for describing the embodiments or the related art. It is obvious that the drawings described below are only some embodiments of the present disclosure. For those skilled in the art, other drawings may be obtained based on these drawings without creative labor.

FIG. 1 is a structural schematic view of a plug adaptor according to some embodiments of the present disclosure.

FIG. 2 is an exploded view of the plug adaptor in FIG. 1.

FIG. 3 is a cross-sectional schematic view of the plug adaptor along line A-A in FIG. 1, when a first plug is in a retracted position.

FIG. 4 is a cross-sectional schematic view of the plug adaptor along line A-A in FIG. 1, when a first plug is in a raised position.

FIG. 5 is a structural schematic view of a rocker in FIG. 2.

FIG. 6 is a partial cross-sectional schematic view of a plug adaptor according to some embodiments of the present disclosure.

FIG. 7 is a cross-sectional schematic view of the plug adaptor along line B-B in FIG. 1, when a first plug is in a stowed position.

FIG. 8 is a partial structural schematic view of a plug adaptor according to some embodiments of the present disclosure.

FIG. 9 is a partial structural schematic view of a plug adaptor according to other embodiments of the present disclosure.

FIG. 10 is a cross-sectional schematic view of a third plug according to some embodiments of the present disclosure.

Reference numerals: 1. Plug adaptor; 11. Housing; 111. Mounting groove; 112. Moving groove; 113. Limiting groove; 114. Plug interface; 115. Accommodation groove; 12. First plug; 121. First plug pin; 13. Rocker assembly; 131, Rocker plate; 1311, Contact segment; 1312, First abutment segment; 1313, Support segment; 1314, Second abutment segment; 1315, Limiting recess; 1316, Limiting portion; 132, Support member; 1321, Abutment groove; 133, Elastic member; 134, Electrical connection element; 14. Electrical connection assembly; 15. Rack; 151. Upper tooth; 152. Lower tooth; 16. Gear; 17. Second plug; 171. Second plug pin; 18. Drive portion; 19. Blocking member; 1a. Third plug; 11a. Third plug pin; 1b. Electrical connection member; 11b. Connection portion; 12b. Abutment portion.

### DETAILED DESCRIPTION

To make the purpose, technical solutions, and advantages of the present disclosure clearer, the following sections will provide a detailed description of the embodiments of the present disclosure with reference to the accompanying drawings.

In the following description, unless otherwise indicated, the same reference numerals denote the same or similar elements in different drawings. The embodiments described in the following exemplary embodiments do not represent all embodiments consistent with the present disclosure. On the contrary, they are merely examples of devices and methods consistent with some aspects of the present disclosure as detailed in the appended claims.

In the description of the present disclosure, it should be understood that terms such as “first,” “second,” etc. are intended for descriptive purposes only and should not be understood as indicating or implying relative importance. For those skilled in the art, the specific meaning of the above terms in the present disclosure can be understood based on the specific context. Furthermore, unless otherwise specified in the description of the present disclosure, “multiple” refers to two or more. “And/or” describes a relationship between associated objects, indicating that three relationships may exist, such as A and/or B, which may represent: A exists alone, A and B exist together, or B exists alone. The character “/” generally indicates that the associated objects before and after it are in an “or” relationship.

Unless otherwise defined, all technical and scientific terms used in the present disclosure have the same meanings as those generally understood by those skilled in the art. The terms used in this specification are intended solely to describe specific embodiments and are not intended to limit the scope of the present disclosure. The term “and/or” used herein includes all combinations of one or more of the listed items.

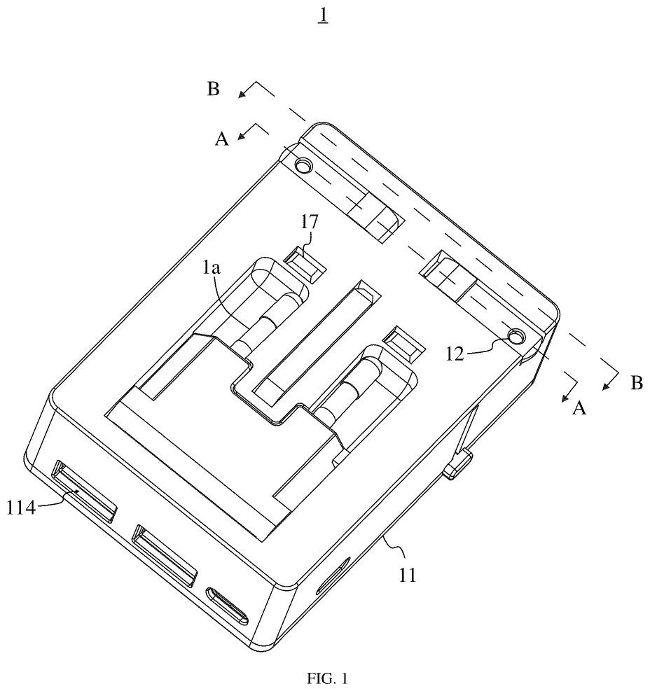

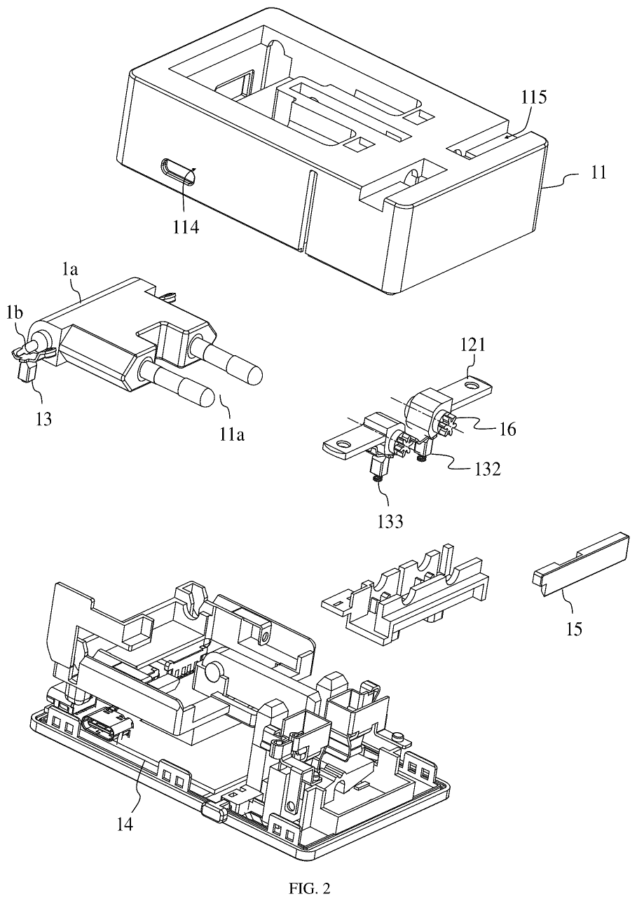

Referring to FIGS. 1 and 2, the present disclosure provides a plug adaptor 1, which includes a housing 11, a first plug 12, at least one rocker assembly 13, an electrical connection assembly 14, and a second plug 17.

It should be noted that the housing 11 has a plug interface 114, through which an external device may be inserted to be electrically connect with the electrical connection assembly 14. The plug interface 114 may be a plug socket or a USB port, and no specific limitation is made herein. The specifications of the first plug 12 are varied. The first plug 12 may be an EU-standard plug, the first plug 12 may be a US-standard plug, or the first plug 12 may be a UK-standard plug. No specific limitations are imposed here.

Referring to FIG. 2, the first plug 12 includes at least two first plug pins 121 rotatably arranged on the housing 11; at least one of the at least two first plug pins 121 slidably abuts against a rocker plate 131 of a corresponding one of the at least one rocker assembly 13 to establish an electrical connection. During rotation of the first plug pin 12, the first plug pin 12 has a raised position where the rocker plate 131 rotates to a state, in which the rocker plate 131 is electrically connected to the electrical connection assembly 14, and has a retracted position where the rocker plate 131 rotates to a state, in which the rocker plate 131 is electrically disconnected from the electrical connection assembly 14.

The first plug 12 is configured to be connected to an external socket to access the mains power. When the first plug pin 121 is in the raised position, the first plug pin 121 is required to partially extend out of the housing 11 to facilitate connection with the external socket. When the first plug pin 121 is in the retracted position, the first plug pin 121 may lie flat on a surface of the housing 11, or the first plug pin 121 may be accommodated inside the housing 11, which is not limited herein.

In some embodiments, referring to FIG. 2, the housing 11 defines an accommodation groove 115, and the first plug pin 121 is disposed in the accommodation groove 115. When the first plug pin 121 is in the raised position, an end of the first plug pin 121 extends from an opening of the accommodation groove 115. When the first plug pin 121 is in the retracted position, the first plug pin 121 is fully accommodated within the accommodation groove 115, thereby enabling the housing 11 to protect the first plug pin 121 and reduce the volume of the power adapter 1, making it convenient for users to store.

The second plug 17 is arranged on the housing 11, and the second plug 17 has an in-use state where the second plug 17 is connected to the mains power and electrically connected to the power connection assembly 14. When the second plug 17 is in the in-use state, the first plug 12 switches to the retracted position.

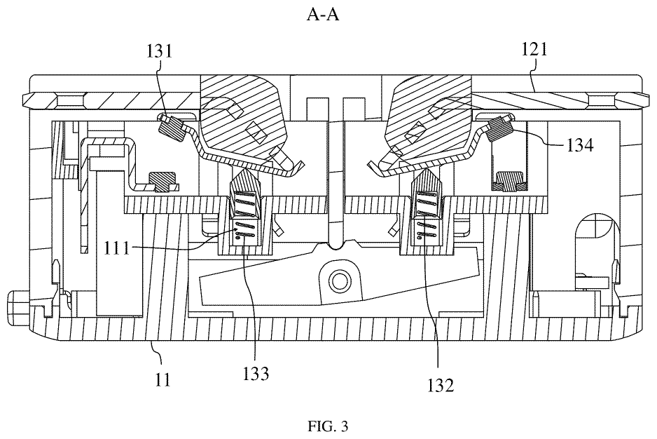

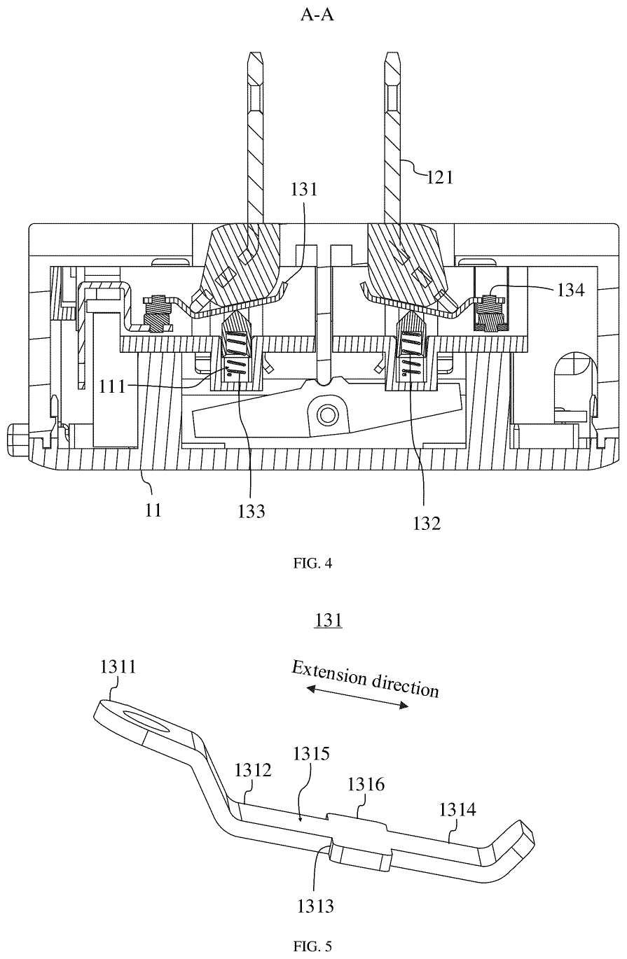

Referring to FIGS. 3 and 4, the rocker assembly 13 is disposed within the housing 11. The rocker assembly 13 includes a rocker plate 131 that can rotate relative to the housing 11, and a corresponding one of the at least one first plug pin 121 slidably abuts against the rocker plate 131 to establish an electrical connection. The first plug pin 121 is electrically connected to the electrical connection assembly 14 via the rocker plate 131. The rocker plate 131 is required to be made of conductive material, such as copper, aluminum, or graphite. There are various ways for the rocker plate 131 to rotate relative to the housing 11. The rocker plate 131 may be rotatably connected to the housing 11 via a shaft, or the rocker plate 131 may rotate around a support member 132 by arranging the support member 132 to abut against a middle portion of the rocker plate 131, which is not limited herein.

The first plug 12 may be mated with the rocker assembly 13 in various ways. For example, one of the two first plug pins 121 can slidably abut against one rocker plate 131. When the first plug 12 is in the retracted position, the electrical connection between one of the first plug pins 121 and the electrical connection assembly 14 is disconnected, preventing the two first plug pins 121 from forming a circuit with the electrical connection assembly 14, thereby disconnecting the electrical connection between the first plugs 12 and the electrical connection assembly 14. Alternatively, the two first plug pins 121 can each slidably abut against two rocker plates 131. When the first plug 12 is in the retracted position, both the first plug pins 121 are disconnected from the electrical connection assembly 14, thereby disconnecting the first plug 12 from the electrical connection assembly 14. The present disclosure does not form limitation in this regard.

The electrical connection assembly 14 is disposed within the housing 11. When the first plug pins 121 switch from the retracted position to the raised position, the first plug pin 121 drives the rocker plate 131 to rotate and come into contact with the electrical connection assembly 14, thereby establishing an electrical connection between the electrical connection assembly 14 and the first plug pin 121. When the first plug pin 121 switches from the raised position to the retracted position, the first plug pin 121 drives the rocker plate 131 to rotate and separate from the electrical connection assembly 14, thereby disconnecting the electrical connection assembly 14 from the first plug pin 121.

There are various ways for the first plug pin 121 to drive the rocker plate 131 to rotate. For example, an end of the rocker plate 131 is rotatably arranged on the housing 11, and the other end of the rocker plate 131 is connected to the first plug pin 121, such that the rocker plate 131 has a rotating end and an abutment end. The first plug pin 121 can slide on the abutment end, thereby rotating the abutment end around the rotating end. When the first plug pin 121 is in the raised position, the abutment end abuts against the electrical connection assembly 14. When the first plug pin 121 is in the retracted position, the abutment end is disconnected from the electrical connection assembly 14.

Alternatively, the middle portion of the rocker plate 131 is rotatably arranged on the housing 11, and the rocker plate 131 has two abutment ends located on both sides of its rotational axis. The first plug pin 121 can slide on one of the two abutment ends to drive the other abutment end to move. When the first plug pin 121 is in the raised position, the other abutment end abuts against the electrical connection assembly 14. When the first plug pin 121 is in the retracted position, the other abutment end is disconnected from the electrical connection assembly 14.

As another example, the middle portion of the rocker plate 131 is rotatably arranged on the housing 11. The rocker plate 131 has a first abutment end and a second abutment end that are located on both sides of its rotational axis. The first plug pin 121 can slide on the first abutment end and the second abutment end. When the first plug pin 121 is in the raised position, the first plug pin 121 abuts against the first abutment end, and the first abutment end abuts against the electrical connection assembly 14. When the first plug pin 121 is in the retracted position, the first plug pin 121 abuts against the second abutment end, and the first abutment end is disconnected from the electrical connection assembly 14. The details are not further listed herein.

Based on the plug adaptor 1 as proposed in the present disclosure, when the second plug 17 is in the in-use state, the first plug 12 switches to the retracted position, and the first plug 12 is disconnected from the electrical connection assembly 14 via the rocker plate 131, thereby preventing users from coming into contact with the first plug pin 121 and being electrocuted, and thus improving the safety of the power adapter 1. In addition, when the first plug 12 switches to the raised position, the first plug pin 121 is electrically connected to the electrical connection assembly 14 via the rocker plate 131, allowing the user to connect the first plug 12 to the mains power, so as to use the plug adaptor 1.

Further referring to FIGS. 3 and 4, in some embodiments of the present disclosure, the rocker assembly 13 further includes a support member 132, which is disposed within the housing 11 and abuts against a surface of the rocker plate 131 away from the first plug pin 121, enabling the rocker plate 131 to rotate around the support member 132. This configuration positions the support member 132 and the first plug pin 121 on opposite sides of the rocker plate 131, preventing interference between the first plug pin 121 and the support member 132 when the first plug pin 121 rotates. Additionally, this configuration fully utilizes the space in the direction where the rocker plate 131 is either close to or far from the first plug pin 121.

Furthermore, referring to FIG. 5, the rocker plate 131 includes a contact segment 1311, which is disposed on an end of the rocker plate 131 in an extension direction and spaced apart from the support member 132. When the first plug pin 121 is in the retracted position, the contact segment 1311 is separated from the electrical connection assembly 14; when the first plug pin 121 is in the raised position, the contact segment 1311 contacts the electrical connection assembly 14. This configuration allows the contact segment 1311 to have a larger rotational range, ensuring that the contact segment 1311 is separated from the electrical connection assembly 14 when the first plug 12 is in the retracted position and that the contact segment 1311 is in contact with the electrical connection assembly 14 when the first plug 12 is in the raised position.

It should be noted that, referring to FIGS. 3 and 4, the rocker assembly 13 further includes an electrical connection element 134, which is arranged on the contact segment 1311. The contact segment 1311 is in abutment with and electrically connected to the electrical connection assembly 14 via the electrical connection element 134. This configuration may reduce the collision between the contact segment 1311 and the electrical connection assembly 14, thereby minimizing wear on the rocker plate 131. Additionally, if the electrical connection element 134 is damaged, only the electrical connection element 134 is required to be replaced, eliminating the need to replace the entire rocker plate 131, which further reduces the maintenance costs of the rocker assembly 13 in the long term.

Specifically, referring to FIG. 5, the rocker plate 131 further includes a first abutment segment 1312 and a second abutment segment 1314. The first abutment segment 1312 and the second abutment segment 1314 are disposed on both sides of the support member 132. An end of the first abutment segment 1312 away from the second abutment segment 1314 is connected to the contact segment 1311. When the first plug pin 121 is in the retracted position, the first plug pin 121 abuts against the second abutment segment 1314, and the contact segment 1311 is separated from the electrical connection assembly 14, thereby disconnecting the electrical connection assembly 14 from the first plug pin 121. When the first plug pin 121 is in the raised position, the first plug pin 121 abuts against the first abutment segment 1312, and the contact segment 1311 contacts the electrical connection assembly 14, thereby electrically connecting the electrical connection assembly 14 to the first plug pin 121.

With this configuration, when the first plug pin 121 is in the raised position, the first plug pin 121 abuts against the first abutment segment 1312, the first abutment segment 1312 and the contact segment 1311 are located on the same side of the support member 132, thereby enabling the first plug pin 121 to act on the side of the rocker plate 131 where the contact segment 1311 is provided, and ensuring that the contact segment 1311 can stably abut against the electrical connection assembly 14. When the first plug pin 121 is in the retracted position, the first plug pin 121 abuts against the second abutment segment 1314, and the second abutment segment 1314 and the contact segment 1311 are located on opposite sides of the support member 132, thereby enabling the first plug pin 121 to act on the opposite side of the rocker plate 131 that is away from the contact segment 1311, thereby ensuring that the contact segment 1311 is separated from the electrical connection assembly 14. Additionally, the contact segment 1311 has a large rotational range.

As can be understood, referring to FIG. 5, the rocker plate 131 includes the contact segment 1311, the first abutment segment 1312, a support segment 1313, and the second abutment segment 1314 that are connected in sequence, and the support member 132 abuts against the support segment 1313. When the first plug pin 121 switches from the retracted position to the raised position, the first plug pin 121 starts from the second abutment segment 1314, passes by the support segment 1313, and abuts against the first abutment segment 1312. When the first plug pin 121 switches from the raised position to the retracted position, the first plug pin 121 starts from the first abutment segment 1312, passes by the support segment 1313, and abuts against the second abutment segment 1314.

Furthermore, referring to FIG. 5, the rocker plate 131 defines a limiting recess 1315 on a surface away from the support member 132. Two walls of the limiting recess 1315 in the extension direction of the rocker plate 131 are located at the first abutment segment 1312 and the second abutment segment 1314, respectively. When the first plug 12 is in the retracted position, the first plug pin 121 abuts against the wall of the limiting recess 1315 located at the second abutment segment 1314. When the first plug 12 is in the raised position, the first plug pin 121 abuts against the wall of the limiting recess 1315 located at the first abutment segment 1312.

This configuration prevents the first plug pin 121 from misaligning with the rocker plate 131 during rotation of the first plug 12 by cooperating with the limiting recess 1315.

Further referring to FIGS. 3 and 4, in some embodiments of the present disclosure, the rocker assembly 13 further includes an elastic member 133, an end of which is connected to the support member 132, and the other end of which is connected to the housing 11. The elastic member 133 is configured to drive the support member 132 to move toward the rocker plate 131. With this configuration, during the rotation of the first plug 12, the support member 132 floats due to the elastic member 133, thereby reducing the rigid wear between the rocker plate 131 and the support member 132, and thus extending the service life of the first plug 12 and the rocker plate 131. In addition, the elastic member 133 applies an elastic force toward the rocker plate 131 on the support member 132. When the first plug pin 121 abuts against the first abutment segment 1312 or the second abutment segment 1314, the support segment 1313 moves toward the plug pin under the drive of the support member 132, thereby restricting a drive portion 18 to the first abutment segment 1312 or the second abutment segment 1314, ensuring that the first plug 12 remains stably in the raised position or the retracted position, and preventing the first plug pin 121 from rotating when the plug adaptor 1 is subjected to shaking, which could affect user operation.

It should be noted that there are many types of elastic members 133. The elastic member 133 may be a spring or an elastic body, which is not limited herein.

Furthermore, referring to FIGS. 3 and 4, the housing 11 defines a mounting groove 111, and the support member 132 defines an abutment groove 1321 that is recessed on a surface away from the rocker plate 131. The support member 132 extends partially into the mounting groove 111. An end of the elastic member 133 is connected to a bottom of the mounting groove 111, and the other end of the elastic member 133 is connected to a bottom of the abutment groove 1321. This configuration guides the elastic member 133 via the mounting groove 111, preventing the support member 132 from disengaging from the support segment 1313 caused by moving along the extension direction of the rocker plate 131 under the drive of the elastic member 133. In addition, by providing the abutment groove 1321 on the support member 132 and inserting one end of the elastic member 133 into the abutment groove 1321, the misalignment between the support member 132 and the elastic member 133 during movement may be prevented, thereby preventing the elastic member 133 from disengaging from the support member 132.

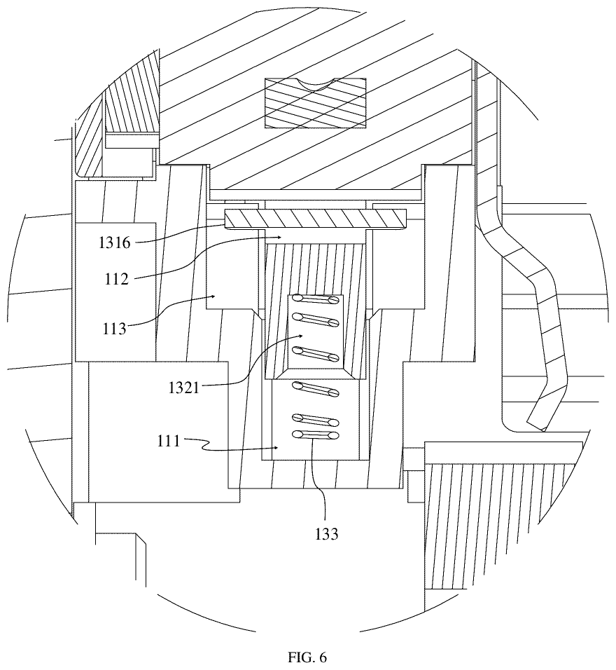

Further referring to FIGS. 5 and 6, in some embodiments of the present disclosure, the housing 11 further includes a moving groove 112. A limiting groove 113 is defined on each of two walls of the moving groove 112 in the direction of the rotational axis of the rocker plate 131. The limiting groove 113 extends in a direction toward or away from a corresponding first plug pin 121. The rocker plate 131 is disposed within the moving groove 112. The support segment 1313 of the rocker plate 131 includes a limiting portion 1316 protruding on each of both ends along the rotational axis, with the limiting portion 1316 extending into a corresponding limiting groove 113. This configuration ensures that the rocker plate 131 moves in the direction toward or away from the corresponding first plug pin 121 through the engagement of the limiting portions 1316 with the limiting grooves 113, thereby preventing the rocker plate 131 from moving along its own extension direction and causing misalignment between the rocker plate 131 and the abutment segment.

It should be noted that a bottom of the moving groove 112 is recessed to define the mounting groove 111, and the support member 132 is disposed within the moving groove 112.

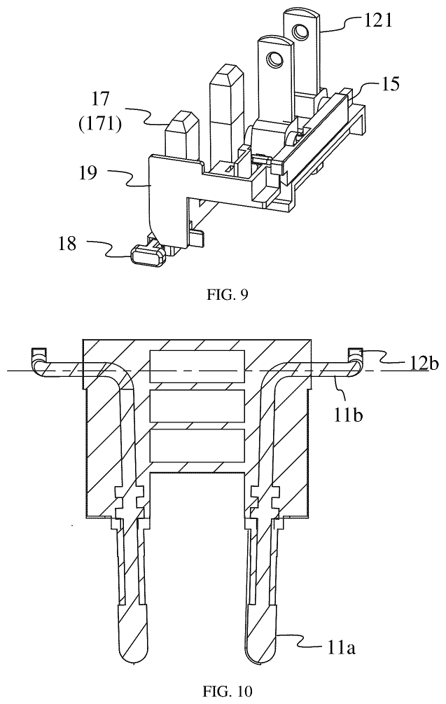

In some embodiments of the present disclosure, further referring to FIGS. 2, 7 to 9, the rotational axes of the two first plug pins 121 are parallel. The free ends of the two first plug pins 121 are movable away from each other to switch from the raised position to the retracted position, and the free ends of the two first plug pins 121 are movable toward each other to switch from the retracted position to the raised position. With this configuration, when the two first plug pins 121 are in the retracted position, the free ends of the two first plug pins 121 extend in directions away from each other. When the two first plug pins 121 are in the raised position, the free ends of the two first plug pins 121 extend in parallel directions.

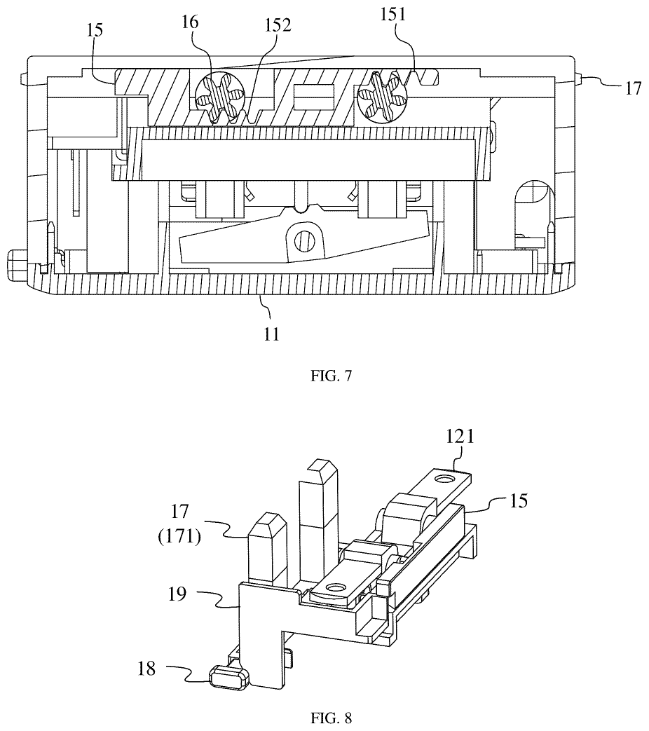

Specifically, referring to FIGS. 7 to 9, the plug adaptor 1 further includes a rack 15 and two gears 16. The rack 15 is slidably arranged on the housing 11 and is movable in a direction toward or away from the free ends of the two first plug pins 121. The rack 15 is arranged with upper teeth 151 and lower teeth 152; the two gears 16 are arranged on the two first plug pins 121, respectively, with one of the two gears 16 meshing with the upper teeth 151 and the other of the two gears 16 meshing with the lower teeth 152, such that the rotation directions of the two first plug pins 121 are opposite, and the two plug pins rotate synchronously. It should be understood that the rotation axis of the gears 16 is collinear with the rotation axis of the corresponding plug pins.

With this configuration, driving one of the pins to rotate causes the corresponding gear 16 to rotate, which, in turn, drives the rack 15 to move in coordination with the upper tooth 151. The rack 15 engages with the other gear 16 via the lower teeth 152, thereby driving the other plug pin to rotate. In this way, rotating one plug pin can drive the other plug pin to rotate, making it convenient for the user to switch the first plug 12 between the raised position and the storage position.

Furthermore, referring to FIGS. 7 to 9, the second plug 17 is slidably arranged on the housing 11 to have a raised position and a retracted position; the plug adaptor 1 further includes a drive portion 18 and a blocking member 19. The drive portion 18 is connected to the second plug 17 and partially exposed outside the housing 11 to drive the second plug 17 to switch between the raised position and the retracted position; the blocking member 19 is movably arranged in the housing 11 and can abut against the rack 15 and the drive portion 18. When the first plug pin 121 switches from the retracted position to the raised position, the rack 15 drives the blocking member 19 to move, causing the blocking member 19 to block the drive portion 18, thereby locking the second plug 17 in the retracted position. When the second plug 17 switches from the retracted position to the raised position, the drive portion 18 drives the blocking member 19 to move, causing the blocking member 19 to block the rack 15, thereby locking the first plug pin 121 in the retracted position. It should be noted that the blocking member 19 blocks the drive portion 18 by extending part of the blocking member 19 into a movement path of the drive portion 18, and blocks the rack 15 by extending part of its path into the rack 15.

With this configuration, when the first plug 12 is in the raised position, the drive portion 18 of the second plug 17 is restricted by the blocking member 19 and cannot extend out of the housing 11; when the second plug 17 is in the raised position, the rack 15 is restricted by the blocking member 19, preventing the first plug 12 from switching to the raised position, which prevents the first plug 12 and the second plug 17 from being in the raised position simultaneously, avoiding the second plug 17 extending from the housing 11 when the first plug 12 is in the raised position and energized, which could cause users to accidentally contact the second plug 17 and suffer an electric shock, thereby enhancing the safety of the power adapter 1. Additionally, users can operate the second plug 17 by driving it via the drive portion 18, facilitating user operation.

It should be noted that the second plug 17 includes at least two second plug pins 171, which are slidably arranged within the housing 11. When the second plug 17 is in the raised position, the second plug pins 171 extend out of the housing 11, enabling the second plug 17 to be connected to an external socket to access the mains power, thereby switching to the in-use state. When the second plug 17 is in the retracted position, the second plug pins 171 are accommodated within the housing 11.

There are various ways in which the blocking member 19 is movably arranged in the housing 11. The blocking member 19 may be slidably arranged in the housing 11, or the blocking member 19 may be rotatably arranged in the housing 11, without specific limitation.

When the blocking member 19 is slidably arranged in the housing 11, the blocking member 19 can move in a direction toward or away from the drive portion 18 and the rack 15. There are various ways in which the drive portion 18 drives the blocking member 19 to slide. For example, the blocking member 19 is arranged with a drive channel, which is inclined in a direction from a position near the drive portion 18 toward a position near the rack 15. The drive portion 18 is at least partially disposed within the drive channel, and the drive portion 18 drives the blocking member 19 to move by cooperating with a channel wall of the drive channel. Alternatively, an outer peripheral wall of the blocking member 19 is arranged with a slope inclined in a direction from a position near the drive portion 18 toward a position near the rack 15. The drive portion 18 drives the blocking member 19 to move by cooperating with the slope. Further examples are not listed herein.

When the blocking member 19 is rotatably arranged in the housing 11, a rotational axis of the blocking member 19 is located between the rack 15 and the blocking member 19, and the rotational axis of the blocking member 19 is parallel to the sliding direction of the second plug 17. The blocking member 19 has a first blocking end and a second blocking end. When the second plug 17 switches from the retracted position to the raised position, the second plug 17 drives the first blocking end to move, causing the second blocking end to move toward the rack 15. The second blocking end is located on a movement path of the rack 15, thereby locking the first pin 121 in the retracted position. When the first plug 12 switches from the retracted position to the raised position, the rack 15 drives the second blocking end to move, causing the first blocking end to move toward the second plug 17. The first blocking end is located on a movement path of the drive portion 18, thereby locking the second plug 17 in the retracted position.

In some embodiments of the present disclosure, further referring to FIGS. 2 and 10, the plug adaptor 1 further includes a third plug 1a and at least two electrical connection members 1b.

The third plug 1a includes at least two third plug pins 11a, which are rotatably arranged on the housing 11 to have a raised position and a retracted position. The specifications of the third plug 1a are varied. The third plug 1a may be an EU-standard plug, the third plug 1a may be an US-standard plug, or the third plug 1a may be a UK-standard plug. No specific limitations are imposed here.

The electrical connection members 1b are connected to the third plug pins 11a in a one-to-one correspondence. Each electrical connection member 1b is arranged with a corresponding rocker assembly 13. When the third plug pin 11a switches from the retracted position to the raised position, the third plug pin 11a drives the electrical connection member 1b to rotate, and the electrical connection member 1b drives the corresponding rocker plate 131 to rotate and come into contact with the electrical connection assembly 14. When the third plug pin 11a switches from the raised position to the retracted position, the third plug pin 11a drives the electrical connection member 1b to rotate, and the electrical connection member 1b drives the corresponding rocker plate 131 to rotate and separate from the electrical connection assembly 14.

With this configuration, the practicality of the power adapter 1 is improved by providing the third plug 1a. Additionally, the third plug 1a can be powered on or off by the electrical connection member 1b and the corresponding rocker assembly 13, thereby enhancing the safety of the power adapter 1.

Specifically, the electrical connection member 1b includes a connection portion 11b and an abutment portion 12b, where an end of the connection portion 11b is connected to a corresponding third plug pin 11a, and the other end of the connection portion 11b extends along a rotational axis of the corresponding third plug pin 11a and is connected to the abutment portion 12b. The abutment portion 12b extends radially from the connection portion 11b, and the connection portion 11b can drive the abutment portion 12b to rotate around the rotational axis of the third plug 1a. It can be understood that the axial direction of the connection portion 11b is collinear with the rotational axis of the third plug pin 11a.

The abutment portion 12b abuts against the corresponding rocker plate 131. When the third plug pin 11a switches from the retracted position to the raised position, the third plug pin 11a drives the abutment portion 12b to rotate, and the abutment portion 12b drives the corresponding rocker plate 131 to rotate until it contacts the electrical connection assembly 14. When the third plug pin 11a switches from the raised position to the retracted position, the third plug pin 11a drives the abutment portion 12b to rotate, and the abutment portion 12b drives the corresponding rocker plate 131 to rotate and separate from the electrical connection assembly 14.

With this configuration, the third plug pin 11a slidably against the corresponding rocker plate 131 via the abutment portion 12b, allowing the rocker plate 131 to be positioned on both sides of the third plug 1a along its rotational axis, thereby fully utilizing the space along the rotational axis of the rocker plate 131. The connection portion 11b extends along the rotational axis of the third plug pin 11a. By setting the abutment portion 12b at the end of the connection portion 11b away from the third plug pin 11a to slidably abut against the rocker plate 131, interference between the third plug pin 11a and the rocker assembly 13 may be avoided when the third plug pin 11a rotates.

Referring to FIG. 2, in some embodiments of the present disclosure, the rocker assemblies 13 are correspondingly matched with the first plug pins 121 and the third plug pins 11a in a one-to-one correspondence, meaning that each first plug pin 121 and each third plug pin 11a is provided with a corresponding rocker assembly 13. This configuration may ensure that when the first plug 12 and the second plug 17 are in their retracted positions, the first pin 121 and the third pin 11a are both disconnected from the electrical connection assembly 14 via the rocker assemblies 13, thereby enhancing the safety of the plug adaptor 1.

In some embodiments of the present disclosure, the first plug 12 is a US-standard plug, the second plug 17 is a UK-standard plug, and the third plug 1a is an EU-standard plug. Since the plug pins of the EU-standard plug are longer, using the same rotational axis alignment may reduce the width of the EU-standard plug within the housing 11. In contrast, the plug pins of the US-standard plug are shorter, so aligning the rotational axes of the two plug pins of the US-standard plug in parallel may reduce the space occupied by the US-standard plug along the length of the housing 11, thereby reducing the overall volume of the housing 11.

Referring to FIG. 1, in some embodiments of the present disclosure, the first plug 12, the second plug 17, and the third plug 1a, when in the raised position, each extend from the same surface of the housing 11. This arrangement ensures that when the first plug 12 and the second plug 17 are both in their raised positions, the first plug 12 is connected to an external socket, while the second plug 17 interferes with the external socket, thereby preventing the first plug 12 from connecting to the external circuit. As a result, only when one of the first plug 12, the second plug 17, and the third plug 1a is in the raised position can the plug adaptor 1 be connected to the external socket, thereby ensuring the safety of the plug adaptor 1.

The above is merely some embodiments of the present disclosure and is not intended to limit the scope of the present disclosure. Any modifications, equivalent replacements, or improvements made within the spirit and principles of the present disclosure should be included within the scope of the present disclosure.

1. A plug adaptor, comprising:
a housing;
an electrical connection assembly, arranged within the housing;
at least one rocker assembly, arranged within the housing and each comprising a rocker plate that is rotatable relative to the housing;
a first plug, comprising at least two first plug pins rotatably arranged on the housing;
wherein at least one of the at least two first plug pins slidably abuts against the rocker plate of a corresponding one of the at least one rocker assembly to establish an electrical connection;
wherein for each first plug pin of the at least one of the at least two first plug pins: during rotation of the first plug pin, the first plug pin has a first raised position where the rocker plate corresponding to the first plug pin rotates to a state, in which the rocker plate is electrically connected to the electrical connection assembly, and the first plug pin further has a first retracted position where the rocker plate corresponding to the first plug pin rotates to a state, in which the rocker plate is electrically disconnected from the electrical connection assembly; and
a second plug, arranged on the housing; wherein the second plug has an in-use state where the second plug is connected to mains power and electrically connected to the power connection assembly; in a case where the second plug is in the in-use state, the first plug switches to the first retracted position.

2. The plug adaptor according to claim 1, wherein each rocker assembly further comprises:
a support member, arranged within the housing and abutting against a surface of the rocker plate away from the first plug pin corresponding to the rocker plate away, for enabling the rocker plate to rotate around the support member.

3. The plug adaptor according to claim 2, wherein the rocker plate comprises a contact segment, and the contact segment is disposed on an end of the rocker plate in an extension direction and spaced apart from the support member;
in a case where the first plug pin is in the first retracted position, the contact segment is separated from the electrical connection assembly;
in a case where the first plug pin is in the first raised position, the contact segment is in contact with the electrical connection assembly.

4. The plug adaptor according to claim 3, wherein the rocker plate further comprises a first abutment segment and a second abutment segment; the first abutment segment is disposed on a side of the support member, and the second abutment segment is disposed on an opposite side of the support member; an end of the first abutment segment away from the second abutment segment is connected to the contact segment;
in a case where the first plug pin is in the first retracted position, the first plug pin abuts against the second abutment segment, and the contact segment is separated from the electrical connection assembly, for disconnecting the electrical connection assembly from the first plug pin;
in a case where the first plug pin is in the first raised position, the first plug pin abuts against the first abutment segment, and the contact segment is in contact with the electrical connection assembly, for electrically connecting the electrical connection assembly to the first plug pin.

5. The plug adaptor according to claim 4, wherein the rocker assembly further comprises an elastic member; an end of the elastic member is connected to the support member, and another end of the elastic member is connected to the housing; the elastic member is configured to drive the support member to move toward the rocker plate.

6. The plug adaptor according to claim 5, wherein the housing defines a mounting groove, and the support member defines an abutment groove that is recessed on a surface away from the rocker plate; an end of the elastic member extends into the mounting groove, and another end of the elastic member extends into the abutment groove.

7. The plug adaptor according to claim 1, wherein the at least two first plug pins are two first plug pins; rotational axes of the two first plug pins are parallel; free ends of the two first plug pins are movable away from each other to switch from the first raised position to the first retracted position, and the free ends of the two first plug pins are movable toward each other to switch from the first retracted position to the first raised position.

8. The plug adaptor according to claim 7, wherein the plug adaptor further comprises:
a rack, slidably arranged on the housing and being movable in a direction toward or away from the free ends of the two first plug pins; wherein the rack is arranged with upper teeth and lower teeth; and
two gears, arranged on the two first plug pins in a one-to-one correspondence; wherein one of the two gears mesh with the upper teeth, and the other of the two gears mesh with the lower teeth, causing rotation directions of the two first plug pins to be opposite and the two first plug pins to be rotatable synchronously.

9. The plug adaptor according to claim 8, wherein the second plug is slidably arranged on the housing to have a second raised position and a second retracted position;
the plug adaptor further comprises:
a drive portion, connected to the second plug and partially exposed outside the housing to drive the second plug to switch between the second raised position and the second retracted position; and
a blocking member, movably arranged in the housing and capable of abutting against the rack and the drive portion;
wherein in a case where the first plug pin switches from the first retracted position to the first raised position, the rack drives the blocking member to move, causing the blocking member to block the drive portion, for locking the second plug in the second retracted position; in a case where the second plug switches from the second retracted position to the second raised position, the drive portion drives the blocking member to move, causing the blocking member to block the rack, for locking the first plug pin in the first retracted position.

10. The plug adaptor according to claim 9, wherein the plug adaptor further comprises:
a third plug, comprising at least two third plug pins; wherein the at least two third plug pins are rotatably arranged on the housing to have a third raised position and a third retracted position; and
at least two electrical connection members, connected to the at least two third plug pins in a one-to-one correspondence;
wherein each of the at least two electrical connection members is matched with a corresponding one of the at least one rocker assembly;
in a case where each third plug pin switches from the third retracted position to the third raised position, the third plug pin drives a corresponding electrical connection member to rotate, and the corresponding electrical connection member drives a corresponding rocker plate to rotate and contact the electrical connection assembly;
in a case where each third plug pin switches from the third raised position to the third retracted position, the third plug pin drives a corresponding electrical connection member to rotate, and the corresponding electrical connection member drives a corresponding rocker plate to rotate and separate from the electrical connection assembly.

11. The plug adaptor according to claim 10, wherein each electrical connection member comprises a connection portion and an abutment portion; an end of the connection portion is connected to a corresponding third plug pin, and another end of the connection portion extends along a rotational axis of the corresponding third plug pin and is connected to the abutment portion; the abutment portion extends radially from the connection portion, and the connection portion is capable of driving the abutment portion to rotate around a rotational axis of the third plug;
wherein the abutment portion abuts against a corresponding rocker plate;
in a case where a corresponding third plug pin switches from the third retracted position to the third raised position, the corresponding third plug pin drives the abutment portion to rotate, and the abutment portion drives the corresponding rocker plate to rotate and contact the electrical connection assembly;
in a case where a corresponding third plug pin switches from the third raised position to the third retracted position, the corresponding third plug pin drives the abutment portion to rotate, and the abutment portion drives the corresponding rocker plate to rotate and separate from the electrical connection assembly.

12. The plug adaptor according to claim 10, wherein at least one of the following is satisfied:
the at least one rocker assembly is correspondingly matched with the at least two first plug pins and the at least two third plug pins in a one-to-one correspondence; and
the first plug is a US-standard plug, the second plug is a UK-standard plug, and the third plug is an EU-standard plug.

13. The plug adaptor according to claim 1, wherein the rocker plate has a rotating end that is is rotatably arranged on the housing and an abutment end that is connected to a corresponding first plug pin; the corresponding first plug pin is slidable on the abutment end, for rotating the abutment end around the rotating end; in a case where the corresponding first plug pin is in the first raised position, the abutment end abuts against the electrical connection assembly; in a case where the corresponding first plug pin is in the first retracted position, the abutment end is disconnected from the electrical connection assembly.

14. The plug adaptor according to claim 1, wherein a middle portion of the rocker plate is rotatably arranged on the housing, and the rocker plate has two abutment ends located on both sides of a rotational axis of the rocker plate; a corresponding first plug pin is slidable on one of the two abutment ends to drive the other of the two abutment ends to move; in a case where the corresponding first plug pin is in the first raised position, the other of the two abutment ends abuts against the electrical connection assembly; in a case where the corresponding first plug pin is in the first retracted position, the other of the two abutment ends is disconnected from the electrical connection assembly.

15. The plug adaptor according to claim 1, wherein a middle portion of the rocker plate is rotatably arranged on the housing, and the rocker plate has a first abutment end and a second abutment end that are located on both sides of a rotational axis of the rocker plate; a corresponding first plug pin is slidable on the first abutment end and the second abutment end; in a case where the corresponding first plug pin is in the first raised position, the corresponding first plug pin abuts against the first abutment end, and the first abutment end abuts against the electrical connection assembly; in a case where the corresponding first plug pin is in the first retracted position, the corresponding first plug pin abuts against the second abutment end, and the first abutment end is disconnected from the electrical connection assembly.

16. The plug adaptor according to claim 3, wherein the rocker assembly further comprises an electrical connection element arranged on the contact segment; the contact segment is in abutment with and electrically connected to the electrical connection assembly via the electrical connection element.

17. The plug adaptor according to claim 4, wherein the rocker plate further comprises a support segment, and the contact segment, the first abutment segment, the support segment, and the second abutment segment are connected in sequence;
the support member abuts against the support segment;
in a case where the first plug pin switches from the first retracted position to the first raised position, the first plug pin starts from the second abutment segment, passes by the support segment, and abuts against the first abutment segment;
in a case where the first plug pin switches from the first raised position to the first retracted position, the first plug pin starts from the first abutment segment, passes by the support segment, and abuts against the second abutment segment.

18. The plug adaptor according to claim 16, wherein the housing defines a moving groove, and a limiting groove is defined on each of two walls of the moving groove along an extension direction of a rotational axis of the rocker plate; the limiting groove extends in a direction toward or away from the first plug pin; the rocker plate is disposed within the moving groove; the support segment of the rocker plate comprises a limiting portion protruding on each of both ends of the along the rotational axis, with the limiting portion extending into a corresponding limiting groove.

19. The plug adaptor according to claim 4, wherein the rocker plate defines a limiting recess on a surface away from the support member; two walls of the limiting recess in the extension direction of the rocker plate are located at the first abutment segment and the second abutment segment, respectively;
in a case where the first plug pin is in the first retracted position, the first plug pin abuts against one of the two walls of the limiting recess located at the second abutment segment;
in a case where the first plug pin is in the first raised position, the first plug pin abuts against the other of the two walls of the limiting recess located at the first abutment segment.

20. A plug adaptor, comprising:
a housing, comprising a surface;
a first plug, comprising two first plug pins rotatably arranged on the housing; wherein each first plug pin has a first raised position to be connected to be an external socket;
a second plug, arranged on the housing and capable of extending out of the surface; wherein the second plug has a second raised position to be connected to be the external socket; and
a third plug, comprising two third plug pins rotatably arranged on the housing; wherein each third plug pin has a third raised position to be connected to be the external socket;
wherein a rotational axis of the third plug is perpendicular to a rotational axis of the first plug;
in a case where only one of the first plug, the second plug, and the third plug is in a corresponding one of the first raised position, the second raised position, and the third raised position and connected to the external socket, an electrical connection to the external socket is formed; and
in a case where more than one of the first plug, the second plug, and the third plug are each in a corresponding one of the first raised position, the second raised position, and the third raised position, the electrical connection to the external socket is disconnected.
